(19) United States
(12) Patent Application Publication
(10) Pub. No.: US 2014/0021708 A1
(43) Pub. Date: Jan. 23, 2014

(54) MOBILE UNIT FOR ROAD-SIDE ACTIVITIES

(71) Applicants: Henry Kistler BERRY, JR., Newport News, VA (US); Henry Kistler BERRY, III, Newport News, VA (US)

(72) Inventors: Henry Kistler BERRY, JR., Newport News, VA (US); Henry Kistler BERRY, III, Newport News, VA (US)

(21) Appl. No.: 13/943,700

(22) Filed: Jul. 16, 2013

Related U.S. Application Data
(63) Continuation of application No. 13/037,745, filed on Mar. 1, 2011, now abandoned.
(60) Provisional application No. 61/400,419, filed on Jul. 28, 2010.

(51) Int. Cl. B60R 9/00; E04G 3/00

(52) U.S. Cl. CPC B60R 9/00; E04G 3/00
USPC 280/769; 182/131

(57) ABSTRACT

A scaffold includes a central platform with a top surface defining a central area, a bottom, a first lateral side, a second lateral side, and a front side. The scaffold also includes a plurality of supports connected to and supporting the platform and at least one extendible platform connected adjacent to the central platform. The extendible platform has a top surface defining an extendible area. The extendible platform is adjustable between an opened position and a closed position, the opened position presenting the extendible area for use, the closed position stowing the extendible area from use. A vehicle incorporating the scaffold, and methods of use of the same, also are provided.

### CROSS-REFERENCE TO RELATED APPLICATION(S)

This application is a continuation of commonly owned U.S. Non-Provisional patent application Ser. No. 13/037,745, filed Mar. 1, 2011 (now abandoned), which relies for priority on U.S. Provisional Patent Application Ser. No. 61/400,419 filed on Jul. 28, 2010, the contents of which are incorporated, herein by reference.

### FIELD OF THE INVENTION

The present patent application relates to mobile units, specifically vehicles, that are adapted to support activities including, but not limited to, trimming trees, vegetation, and other flora adjacent to a road.

### DESCRIPTION OF RELATED ART

As should be apparent to those skilled in the art, local, state and federal agencies are responsible for trimming roadside flora to keep vegetation from encroaching upon a roadway and, thereby, interfering with passability of the roadway.

Presently, when highway workers are tasked with clearing roadside vegetation, they typically rely upon a vehicle with a crane, boom, or similar apparatus so that workers may reach vegetation at specific heights above the road surface.

In one known example, a vehicle with a workman's bucket connected to an extendible arm (or boom) assists with clearing vegetation above a height easily accessible from the ground.

A disadvantage with this approach lies in the fact that applicable safety guidelines for operation of such vehicles requires that the vehicle be secured before the boom with an operator in the bucket may be deployed. To secure the vehicle, the vehicle must be stopped so that the wheels may be secured. Often, to prevent the vehicle from tipping over, pontoons are extended laterally from the body of the vehicle.

While this method has proven effective, one drawback with this approach is that the vehicle must be secured every few feet along a roadway to assure that the workers arc able to cut the vegetation safely.

As should be apparent to those skilled in the art, the constant stopping and securing of the vehicle every few feet along a roadway adds considerably to the time needed to clear vegetation adjacent to the roadway.

A need has developed to reduce the total time required for clearing vegetation adjacent to and above a road surface.

### SUMMARY OF THE INVENTION

The present invention is intended to address one or more of the deficiencies noted above with respect to the prior art.

The present invention capitalizes on an appreciation that OSHA (“Occupational Safety and Health Administration”), together with other federal, state and local safety guidelines, permit a vehicle to remain in motion so long as the vehicle meets certain safety requirements.

The present invention, therefore, provides a vehicle, scaffold, and method of using the same where the vehicle may remain in motion while workers are free to clear vegetation adjacent to and above a roadway surface.

The present invention also provides a scaffold that includes a central platform with a top surface defining a central area, a bottom, a first lateral side, a second lateral side, and a front side. A plurality of supports is connected to and supports the platform. At least one extendible platform connects adjacent to the central platform. The extendible platform has a top surface defining an extendible area and is adjustable between an opened position and a closed position. The opened position presents the extendible area for use and the closed position stows the extendible area from use.

In one contemplated embodiment, the at least one extendible platform is connected act adjacent to one of either the first lateral side or the second lateral side of the central platform.

In another embodiment, the at least one extendible platform is connected adjacent to the front side of the central platform.

In one variation, the extendible platform may slide to a position beneath the central platform from the opened position to the closed position.

In another variation, the at least one extendible platform may pivotally rotate about a vertical axis perpendicular to a plane defined by the central area to a position beneath the central platform from the opened position to the closed position.

The present invention also contemplates that the at least one extendible platform collapses from the opened position to the closed position by pivoting along a horizontal axis parallel to a plane defined by the central area.

In a further embodiment, the central platform and at least one extendible platform may form a unitary structure that rotates as a whole to present the extendible platform for use.

Additionally, the present invention contemplates that the at least one extendible platform includes a first extendible platform positioned adjacent to the central platform at the first lateral side and a second extendible platform positioned adjacent to the central platform at the second lateral side.

The present invention also provides for the plurality of supports to be connected to and support the central platform from the bottom of the central platform.

In one contemplated embodiment of the present invention, the at least one extendible platform is at a height that differs from a height of the central platform.

In another, the central platform and the at least one extendible platform are at the same height.

The present invention also contemplates a method of use of a scaffold that includes extending the at least one extendible platform from the closed position to the opened position, disposing an operator on the scaffold, positioning the scaffold at a first position, permitting performance of a first operation from the scaffold at the first position by the operator, positioning the scaffold at a second position, and permitting performance of a second operation from the scaffold at the second position by the operator. With respect to this method, the scaffold is moved from the first position to the second position while the operator is disposed thereon.

The present invention additionally provides for a vehicle that includes a body, a plurality of wheels supporting the body to establish a mobile unit, a steering device adapted to steer the body, and a scaffold. The scaffold includes a central platform with a top surface defining a central area, a bottom, a first lateral side, a second lateral side, and a front side, a plurality of supports connected to and supporting the platform, and at least one extendible platform connected adjacent to the central platform, the extendible platform having a top surface defining an extendible area, the at least one extendible platform being adjustable between an opened position and a closed position, the opened position presenting the extendible area for use, the closed position stowing the extendible area from use.

One embodiment of the vehicle of the present invention contemplates that the at least one extendible platform is connected adjacent to one of either the first lateral side or the second lateral side of the central platform.

Another embodiment of the vehicle contemplates that the at least one extendible platform is connected adjacent to the front side.

Still further, the present invention provides for an arrangement for a vehicle where the extendible platform slides to a position beneath the central platform from the opened position to the closed position.

Additionally, the present invention provides for a vehicle where the at least one extendible platform pivotally rotates, about a vertical axis perpendicular to a plane defined by the central area, to a position beneath the central platform from the opened position to the closed position.

In another contemplated embodiment, a platform that combines the at least one extendible platform and the central platform together may be rotated about a central axis from a closed to an opened position.

Still further, the vehicle may be constructed so that the at least one extendible platform collapses from the opened position to the closed position by pivoting along a horizontal axis parallel to a plane defined by the central area.

In another contemplated embodiment, the vehicle includes a first extendible platform positioned adjacent to the central platform at the first lateral side and a second extendible platform positioned adjacent to the central platform at the second lateral side.

A further embodiment of the present invention contemplates a vehicle where the plurality of supports is connected to and supports the central platform from the bottom of the central platform.

In a variation, the vehicle may include at least one extendible platform that is at a height that differs from a height or is at the same height as the central platform.

The present invention also contemplates a method of use of the vehicle that includes extending the at least one extendible platform from the closed position to the opened position, disposing an operator on the scaffold, positioning the vehicle at a first position, permitting performance of a first operation from the scaffold at the first position by the operator, positioning the vehicle at a second position, and permitting performance of a second operation from the scaffold at the second position by the operator. The vehicle is moved from the first position to the second position while the operator is disposed on the scaffold.

In connection with the method of use of the vehicle, the first and second operations may involve cutting, trimming, and/or manipulation of flora adjacent to a road.

Other aspects of the present invention will be made apparent from the discussion that follows.

### BRIEF DESCRIPTION OF THE DRAWINGS

The present invention will now be described in connection with the following drawings in which:

FIG. 1 is a side view of a vehicle incorporating aspects of the present invention;

FIG. 2 is a front, elevational view of the vehicle illustrated in FIG. 1, showing extendible platforms extending from both sides of a central platform on the vehicle;

FIG. 3 is a top, plan view of one embodiment of a scaffold according to the present invention, showing a central platform and two steps, which embodiment is illustrated in connection with the vehicle shown in FIG. 1;

FIG. 4 is a top, plan view of another embodiment of a scaffold according to the present invention;

FIG. 5 is a top plan view of the scaffold illustrated in FIG. 3, showing the addition of a plurality of handrails thereto;

FIG. 6 is a front, elevational view of a further embodiment of the scaffold of the present invention;

FIG. 7 is a perspective illustration of a portion of the scaffold illustrated in FIG. 6, showing the position of several handrails and one of the extendible platform associated therewith;

FIG. 8 is a top, plan view of the scaffold illustrated in FIG. 3, showing the positions of the extendible platforms in a closed or non-deployed condition;

FIG. 9 is a top, plan view of the scaffold illustrated in FIG. 8, showing the positions of the extendible platforms in an opened or deployed condition;

FIG. 10 is a top, plan view of an additional embodiment of the present invention. showing the location of an extendible platform at the front of the central platform;

FIG. 11 is a top, plan view of a further embodiment of the present invention, showing extendible platforms that pivot outwardly from the closed to the opened position;

FIG. 12 is a front, elevational view of yet another contemplated embodiment of the present invention, showing extendible platforms that fold upwardly from the closed position to the opened position;

FIG. 13 is a front, elevational view of an embodiment of the present invention where the extendible platforms collapse in an accordion-like fashion from the opened to the closed positions;

FIG. 14 is a detailed side view of the top end of one of the vertical supports, showing the inclusion of an elastic member between the support and the bottom of the central platform;

FIG. 15 is a side view of another embodiment of a vehicle according to the present invention, illustrating a platform that is rotatable atop the vehicle;

FIG. 16 is a top view of the rotating platform illustrated in FIG. 15, showing the platform in a first position, which in line with the centerline of the vehicle, and also indicating the position of the platform in a second position, perpendicular to the first; and

FIG. 17 is a side view of a further embodiment of a vehicle according to the present invention, illustrating a removable platform atop the vehicle.

### DETAILED DESCRIPTION OF EMBODIMENT(S) OF THE INVENTION

While the present invention is described in connection with one or more embodiments thereof, the present invention is not intended to be limited to the specific embodiments described herein. As should become apparent to those skilled in the art after appreciating the breadth of the instant discussion, there are numerous variations and equivalents f the embodiments discussed herein that may be employed to practice the present invention. The present invention is intended to encompass those variations and equivalents.

As a preliminary matter, it is noted that the drawings appended hereto are intended to be illustrative of the present invention. The drawings are not to scale, unless otherwise indicated.

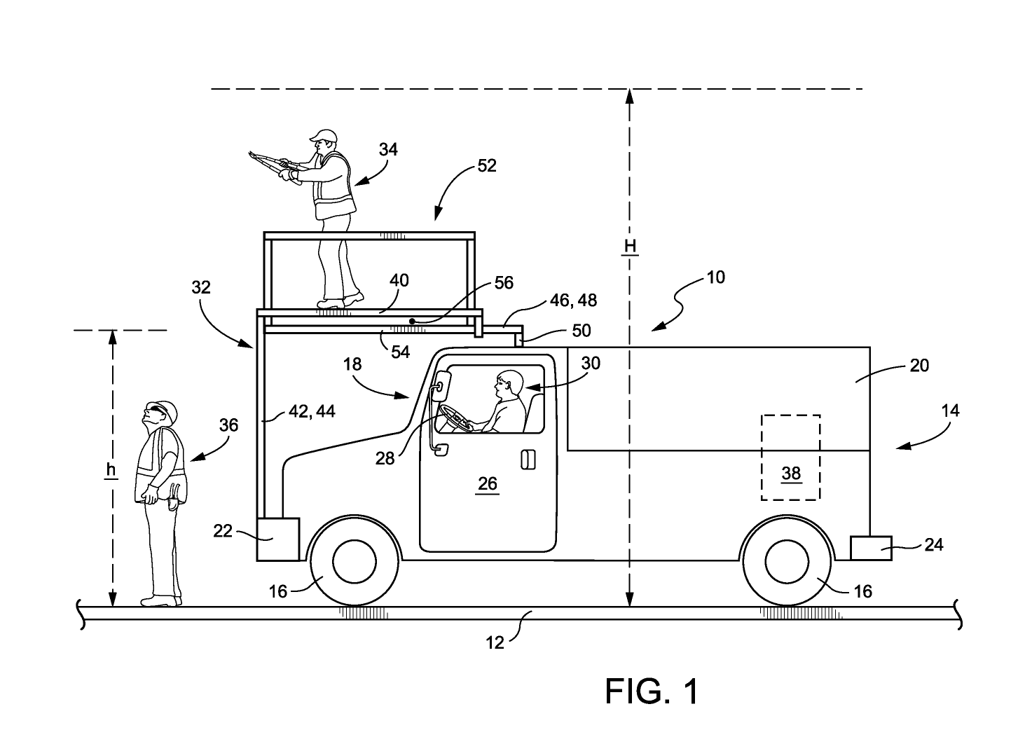

FIG. 1 is a side view of one contemplated embodiment of a vehicle 10 according to the present invention. In connection with the description of the present invention, the vehicle 10, at least in one contemplated environment for use, is intended to assist with manipulation, specifically the cutting and removal, of flora F adjacent to a road 12 or road surface. Flora F is intended to encompass trees, vines, and large shrubs, among other things, as should be apparent to those skilled in the art. Flora F also may be referred to as “vegetation” herein.

While the present invention is described in connection with the trimming of trees and flora F adjacent to a road 12, the present invention may be employed for many other types of operations. For example, it is contemplated that the vehicle 10 of the present invention may be employed in circumstances where the wails of a tunnel need to be cleaned. Alternatively, the vehicle 10 of the present invention may be employed where a vertical surface needs to be painted or otherwise refurbished. In still a further embodiment, the vehicle 10 might be employed by those responsible for changing light bulbs in roadside lamps or even fixtures on buildings. For example, it is contemplated that the vehicle 10 of the present invention might be employed to assist with changing light bulbs in the canopies that extend over the gas pumps at a gas station. The sheer magnitude of the possible applications of the present invention discourages the presentation of an exhaustive list of potential uses. It is to be understood, however, that the present invention is not limited solely to the cutting and trimming of roadside flora F. To the contrary, as should be apparent to those skilled in the art, any number of possible uses may be found for the present invention.

It is also noted that the present invention will be discussed in connection with the cutting and trimming of flora F adjacent to a road 12. However, as should be immediately apparent, the present invention may be employed off-road as well. Specifically, the scope of the present invention is intended to encompass both on-road and off-road environments.

As will become apparent, the present invention is intended to encompass a vehicle, a method of use of the vehicle, a scaffold, and a method of use of the scaffold, among other aspects that should be apparent to those skilled in the art. A specific reference to any single aspect of the present invention is not intended to be limiting of the invention. Certain aspect of the invention will be discussed in connection with “the present invention” to simplify the discussion set forth below. In other words, reference to “the present invention” in one or more contexts is not intended to be limiting thereof.

As noted above, FIG. 1 provides a side view of a vehicle 10 according to the present invention. In FIG. 1, the vehicle 10 is disposed on a horizontal surface, such as a road 12. The vehicle 10 includes a body 14 with four wheels 16. The body 14 of the vehicle 10 includes a cab 18 at a forward position and a cargo compartment 20 at a rearward position. A front bumper is illustrated at the front of the vehicle 10, and a rear bumper 24 is illustrated at the rear thereof. For purposes of convention, the cab 18 includes a door 26. The vehicle 10 also includes a steering device, such as a steering wheel 28. A vehicle operator 30 is illustrated in FIG. 1 to assist with an understanding of the drawing.

With respect to the vehicle 10, it is contemplated that any vehicle size, style, or type may be employed without departing from the scope of the present invention. For example, the vehicle 10 may be a. utility vehicle of the type employed by a utility company to service electrical or telephone poles. Alternatively, the vehicle 10 may be a pick-up truck or van. The exact size, style, and appearance of the vehicle are not critical to practice of the present invention. in fact, it is contemplated that different vehicle types, styles, and sizes may be selected depending upon the specific parameters associated with the road-side operation to be performed.

With continued reference to FIG. 1, it is noted that the vehicle 10 includes four wheels in a standard configuration. However, as should be apparent, the vehicle 10 is not limited to a four wheel configuration. The vehicle 10 may include a larger or smaller number of wheels, as required or as desired. For example, it is possible that the present invention may be employed using a large vehicle 10, such as a dump truck. A typical dump truck includes two wheels at the front and four wheels at the rear. While unlikely, it is also contemplated that the present invention may be employed in connection with a tracked vehicle (such as snow groomer, or the like). As noted, the configuration of the vehicle 10 is not critical to operation of the present invention.

The vehicle 10 includes a scaffold 32, which is mounted above the cab 18 in the version of the present invention illustrated in FIG. 1. Details of the scaffold 32 are provided below.

Before delving into the details of specific embodiments, it is noted that the precise positioning of the scaffold 32 on the vehicle 10 is not critical to practice of the present invention. Specifically, in FIG. 1, the scaffold 32 is shown positioned above the cab 18. While there are perceived to be certain advantages to locating the scaffold 32 above the cab 18, those skilled in the art may position the scaffold 32 at any location with respect to the vehicle 10 without departing from the present invention.

Concerning the positioning of the scaffold 32, it is contemplated that positioning the scaffold 32 at the front of the vehicle presents several advantages over other positions on (or with respect to) the vehicle 10. For the use contemplated with respect to the present invention, the vehicle 10 is intended to be driven in a forward fashion, at low speeds, so that an operator 34 positioned on the scaffold 32 may reach overhanging branches, limbs, and other flora F that require trimming. As such, it is considered advantageous for the operator 34 to be at a position near to the front of the vehicle 10 to clear the flora F before (or at the same time) the vehicle 10 reaches the offending flora F. If the scaffold 32 is positioned behind the front of the vehicle 10, it is anticipated that the flora F may impact with the vehicle 10, presenting difficulties to the operator 34 wishing to clear such flora F.

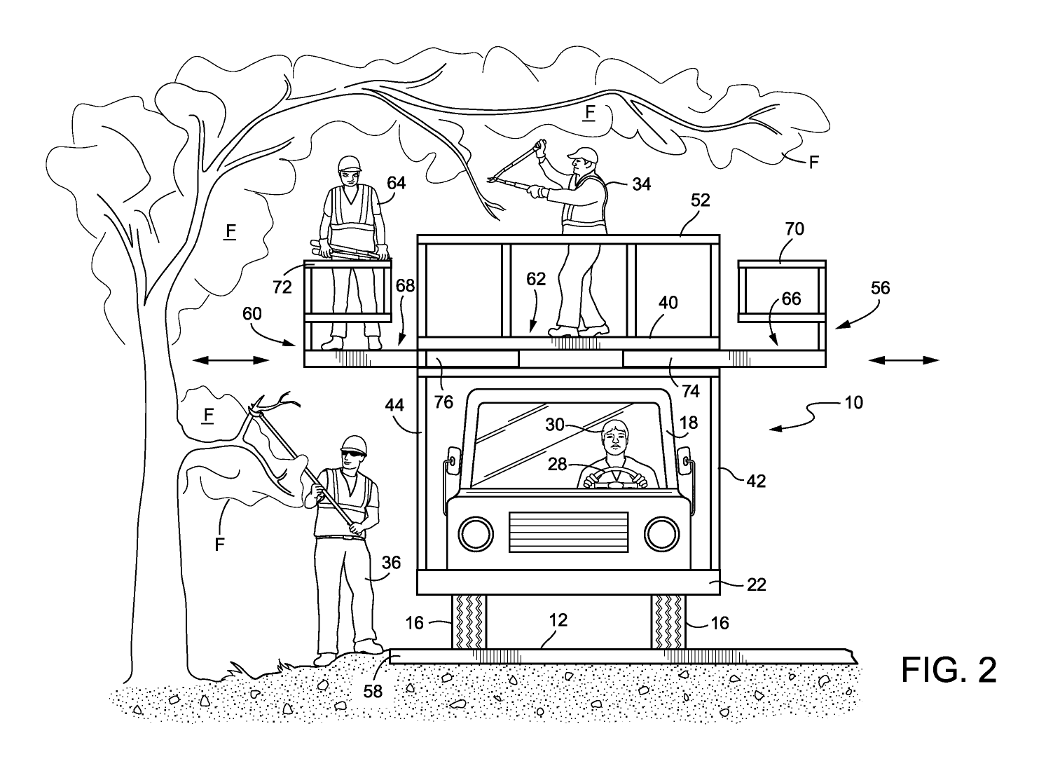

Concerning the clearing of flora F, the operator 34 is contemplated to work in conjunction at least with a ground-based operator 36 and other operators, as will be discussed in greater detail with respect to FIG. 2. Specifically, it is contemplated that the ground operator 36 will walk ahead of the vehicle 10 to clear flora F up to a height h, which is consistent with the reach of the ground operator 36. The scaffold operator 34, in turn, will clear flora F up to a height H consistent with the reach of the scaffold operator 34. Together, then, the operators 34, 36 are able to clear flora F to a height H from their respective positions.

In connection with the clearing of flora F, it is contemplated that the operators 34, 36 may be provided with a handheld device, such as a chainsaw (or other suitable cutting apparatus) to clear the flora F adjacent to and above the vehicle 10. The cutting device (not shown) may operate independently of the vehicle 10 or may be powered by a power source 38 disposed on or in the vehicle 10.

For example, it is contemplated that the vehicle may include a hydraulic generator that generates hydraulic power. Alternatively, the vehicle may include an electric generator that produces electrical power. Regardless of the type of power generated (i.e., hydraulic, electric, etc.), the power source 38 may be disposed conveniently within the cargo compartment 20, for example. The cutting devices that are handled by the operators 34, 36 may be connected, via electrical cables or hydraulic pipes, to the power source 38. In this manner, the operators 34, 36 may be provided with a ready supply of power for operation of the handheld cutting devices. In addition, as should be apparent to those skilled in the art, the power source 38 may be configured to support a plurality of handheld devices, individually or simultaneously.

As should be apparent to those skilled in the art, the power source 38 may be any suitable power source for operation of the handheld devices carried by the operators 34, 36. In the example where the operators 34, 36 are cleaning the interior of a tunnel, for example, the power source 38 may be a suitable pump that provides high power water (or a cleaning solution) to the handheld units carried by the operators 34, 36. The exact nature or type of power source 38 provided on the vehicle 10 is not critical to practice of the present invention.

With renewed reference to FIG. 1, it is noted that the scaffold 32 includes a central platform 40, on which the operator 34 is positioned. In this example, the central platform 40 is supported by two upright supports 42, 44 (of which only support 42 is visible in this illustration). As shown, the supports 42, 44 extend upwardly from the front bumper 22 to the bottom of the central platform 40.

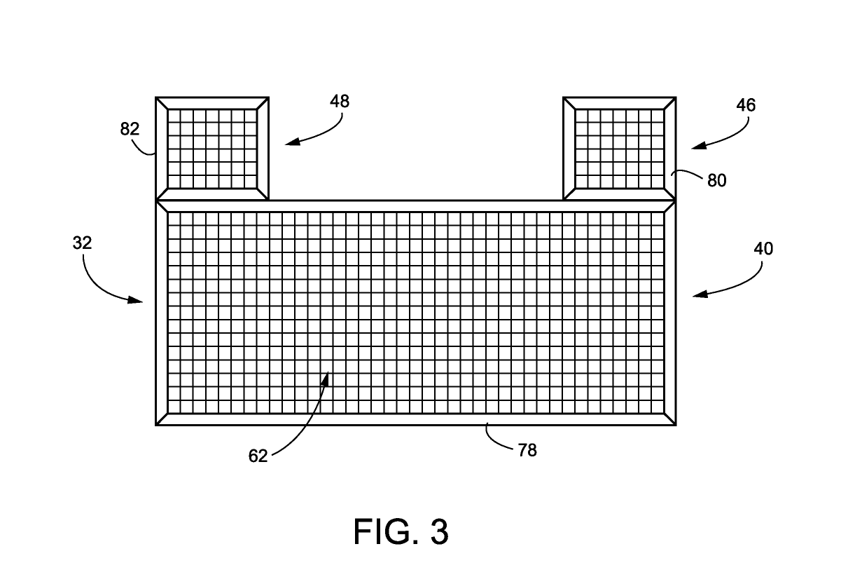

The rear of the central platform 40 is provided with steps 46, 48 (of which only step 46 is visible in this illustration). Both of steps 46 and 48 are more clearly illustrated in FIG. 3, which is discussed below. The steps 46, 48 permit the operator to step down from the central platform onto the top of the vehicle 10. The steps 46, 48 are supported by supports 50.

It is noted that the scaffold 32 of the present invention does not need to include steps 46, 48 to permit ingress and egress to and from the central platform 40. Other means of ingress and egress, such as one or more ladders, may be employed without departing from the scope of the present invention.

As also illustrated in FIG. 1, the central platform 40 is provided with handrails 52 for the safety of the operator 34. The handrails 52, details of which are discussed in greater detail below, may be of any suitable shape and variety, as required by law or as desired.

In addition, while handrails 52 are illustrated, they are not required to practice the present invention. It is contemplated, for example, that the central platform 40 may be surrounded by solid or perforated walls to provide additional safety for the operator 34.

Under the central platform 40, there is a horizontal structural member 54. In this illustration, the structural member 54 extends from the supports 42, 44 to a position adjacent to the steps 46, 48. The structural member 54 provides support for one or more extendible platforms 56, which are discussed in. greater detail below. The structural member 54 also provides additional strength and stability for the scaffold 32, generally. The structural member 54 is not required to practice the present invention. As should be apparent to those skilled in the art, other structural members may be employed, as required or desired for the particular implementation selected.

Before discussing many of the different embodiments contemplated for the present invention, it is noted that the scaffold 32, including its many parts and components, is contemplated to be made from steel. The present invention, however, is not limited to a steel construction. To the contrary, the various elements of the scaffold 32 may be made from any iron-based alloy. In addition, it is contemplated that the scaffold 32 may be made from aluminum or an aluminum alloy to lighten the total weight thereof. Any other suitable material may be employed for one or more of the components of the scaffold 32 including, but not limited to, composite materials, plastic, fiberglass, and the like. It is noted that, while specific materials are listed for the scaffold 32, the present invention does not require any particular material and is not intended to be limited thereby.

FIG. 2 is a front, elevational view of the vehicle 10 illustrated in FIG. 1. This illustration provides a more comprehensive overview of one embodiment of the present invention.

As in FIG. 1, the vehicle 10 is positioned on a road surface 12, adjacent to an edge 58 of the road 12. As shown in FIG. 1, an operator 34 is positioned on the central platform 40, and an operator 36 is positioned on the ground 60 adjacent to the road surface 12. As discussed above, the road-side operator 36 clears the ground-level flora F and the operator 34 clears the flora F above the vehicle 10 and at a higher elevation from the ground.

FIG. 2 illustrates two of the extendible platforms 56, 60 of the present invention. The extendible platforms 56, 60 are illustrated in the opened or deployed condition (or position). This stands in contrast to FIG. 1, where the extendible platform 56 is shown in the closed or non-deployed condition. Naturally, the extendible platform 60 is not visible in FIG. 1.

As should be apparent from FIG. 2, the central platform 40 includes a top surface on which the operator 34 stands. For reference, this area is referred to as the “central area” 62, which is illustrated in the top view presented in FIG. 3. Similarly, the extendible platforms 56, 60 include top surfaces on which an operator 64 may stand. The areas defined by the extendible platforms 56, 60 are referred to as “extendible areas” 66, 68.

It is noted that the operators 34, 64 may be the same person who has moved from the central area 62 to the extendible area 68. Alternatively, the operators 34, 64 may be separate individuals.

Like the central platform 40, the extendible platforms 56, 60 include handrails 70, 72. The handrails 70, 72 are not required to practice the present invention, but they are considered as desirable from a safety standpoint, among other reasons.

Before turning to FIG. 3, it is noted that the extendible platforms 56, 60 include beams 74, 76 that extend under the central platform 40. As will be discussed in greater detail bellow, the beams 74, 76 permit the extendible platforms 56, 60 to slide under the central platform 40 when in the closed or non-deployed position.

It is noted that, while FIG. 2 illustrates two extendible platforms 56, 60, embodiments of the present invention may include a fewer or a larger number of extendible platforms, as required or desired.

In one embodiment, it is contemplated that a single extendible platform 60 will be provided in connection with the scaffold 32. If a single extendible platform 60 is provided, it is anticipated that the extendible platform 60 will be deployable to the opened position at the passenger side of the vehicle 10. If positioned on the passenger side of the vehicle 10, the extendible platform 60 permits trimming of flora F at least at a position adjacent to the road surface 12 when the vehicle 10 travels in the usual manner on a United States highway. Naturally, in Great Britain (and other countries following the British example), the orientation would be reversed, and the extendible platform 56 would be the singular platform.

With respect to the opened and closed positions for the extendible platforms 56, 60 it is noted that the opened (or deployed) position presents the extendible areas 66, 68 for use. When in the closed or non-deployed condition, the extendible platforms 56, 60 do not present the extendible areas 66, 68 for use.

FIG. 3 is a top view illustration of the scaffold of the present invention, illustrating the juxtaposition of the central platform 40 in relation to the steps 46, 48. Here, the extendible platforms 56, 60 are in the closed (or non-deployed) condition.

The central platform 40 and the steps 46, 48 include a perforated structure, such as a grate, as illustrated. A grate is contemplated for this embodiment of the invention for several reasons. First, a grate typically is lighter in weight than a solid surface made from the same material. As a result, a grate is anticipated to lighten the overall weight of the scaffold 32. Second, a grate permits water (i.e., rain), debris, and detritus to fall through the grate to the ground. Other aspects of a grate material should be apparent to those skilled in the art.

In the illustrated example, the grate material is contemplated to be steel. However, any other suitable material may be employed for the grate, as should be apparent to those skilled in the art. For example, the grate may be made from any alloy of iron, aluminum, or other suitable metal. In addition, the grate may be made from non-metallic materials such as plastics, ceramics, composite materials, and fiberglass, to name a few possible options.

While a grate is illustrated for the central platform 40 and the steps 46, 48, a grate need not be employed. Other materials arid constructions may be used without departing from the scope of the present invention. For example, it is contemplated that the central platform 40 and the steps 46, 48 may incorporate a solid material, such as a plastic or fiberglass sheet as the supportive surface. Other materials, as noted herein, and as should be apparent to those skilled in the art, maybe employed without departing from the scope of the present invention.

With continued reference to FIG. 3, it is noted that the central platform 40 and the steps 46, 48 are surrounded by structural frames 78, 80, 82. In the illustrated embodiment, the structural frames 78, 80, 82 are contemplated to be made from steel. As should be apparent, any other suitable material may be employed without departing from the scope of the present invention. In addition, it is noted that the frames 78, 80, 82 may be omitted from the scaffold 32 without departing from the scope of the present invention.

With respect to FIG. 3, the central platform 40 is shown as a rectangular platform. While this is considered as the most likely, practicable design, the present invention is not intended to be limited to such a shape. The central platform 40 may have any desirable shape including, but not limited to a U-shape, an L-shape, any polygonal shape, or a curved configuration, among many others. In other words, the present invention is not intended to be limited to any particular shape for the central platform 40. Similarly, the extendible platforms 56, 60 are not limited to any particular shape or configuration.

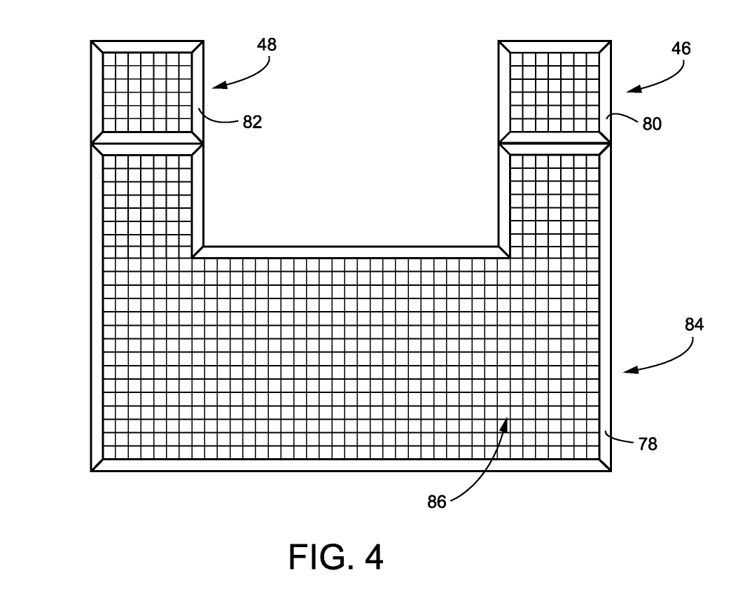

FIG. 4 is a top plan view of a variation of the central platform 84, where the central platform 84 has a U-shaped construction. The U-shape of the central platform 81 defines a larger central area 86 that permits, among other advantages, a greater working area for the operator 34, for example. This larger central platform 84 may be advantageously employed on larger vehicles 10 than the embodiment illustrated in FIG. 3, for example.

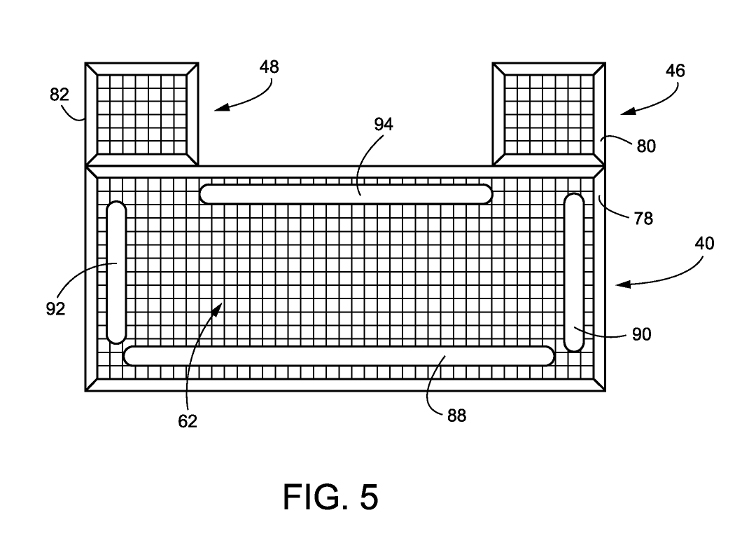

FIG. 5 is a top plan view of the embodiment of the central platform 40 that is illustrated in FIG. 3. Here, handrails 88, 90, 92, 94 have been added at the periphery of the central platform 40. The handrail 88 is positioned near to the front edge of the central platform 40. The handrail 90 is positioned adjacent to a first lateral edge of the central platform 40. The handrail 92 is positioned adjacent to a second lateral edge of the central platform 40. The handrail 94 is positioned adjacent to the rear edge of the central platform 40. While these four handrails 88, 90, 92, 94 are contemplated in this particular embodiment, a larger or a fewer number may be employed without departing from. the scope of the present invention.

In connection with the handrails 88, 90, 92, 94 (or any of the other handrails described herein), it is contemplated that the handrails 88, 90, 92, 94 may be removable, foldable, and/or collapsible. It may be desirable, for example, to remove, fold, or collapse the handrails 88, 90, 92, 94 to reduce the overall height of the vehicle 10. Naturally, the handrails 88, 90, 92, 94 need not be removable, foldable or collapsible. The present invention is intended to encompass each of these variations.

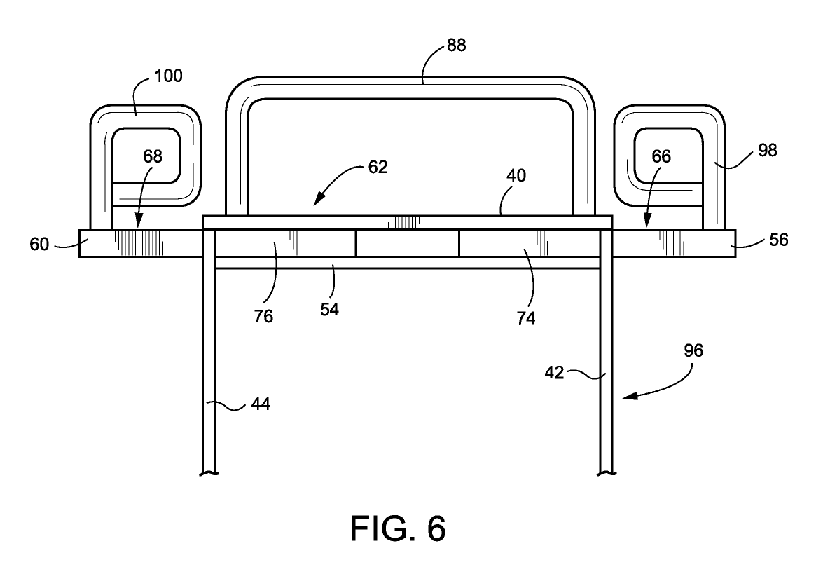

FIG. 6 is a front view of the scaffold 96 of the present invention, which is a variation on the scaffold 32 illustrated in FIG. 2, for example. In this drawing, the scaffold 96 is shown with the extendible platforms 56, 60 in the opened or deployed positions. Handrails 98, 100 are provided for each of the extendible platforms 56, 60. The handrails 98, 100 differ in their appearance from the handrails 70, 72 that are illustrated in FIG. 2. The handrails 98, 100 are intended to be removable, foldable, or collapsible to facilitate stowage of the extendible platforms 56, 60 in the closed or non-deployed condition.

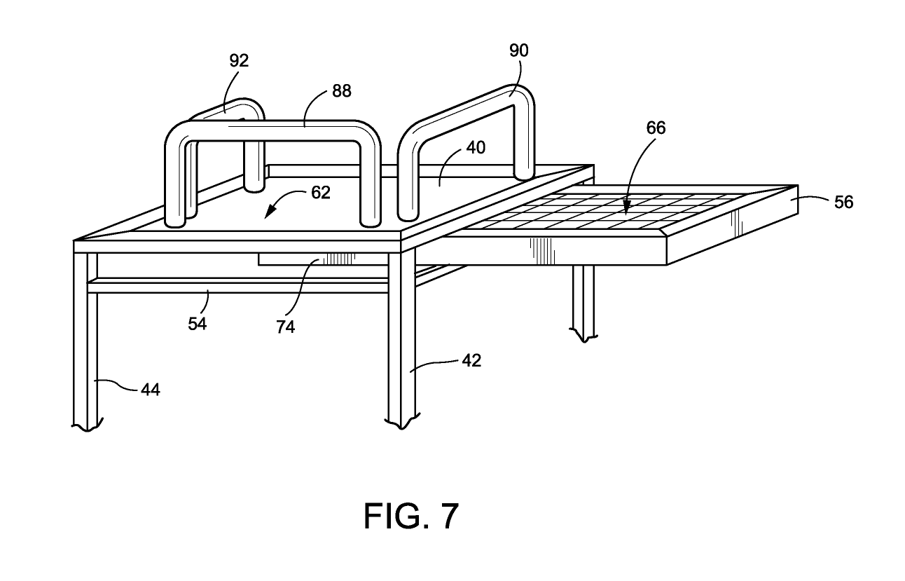

FIG. 7 is a perspective illustration of the scaffold 96 illustrated in FIG. 6. Here, for simplicity, the handrails 94, 98 are omitted. In addition, for simplicity, the extendible platform 60 is not shown.

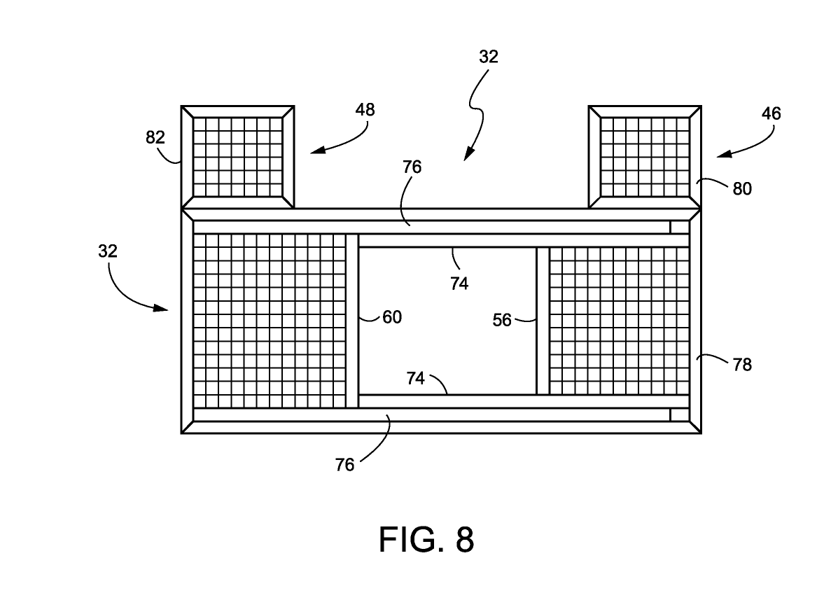

FIG. 8 is a top view of the scaffold 32, 96 of the present invention. In this illustration, the central area 62 (i.e., the grate) has been removed so that the positions of the extendible platforms 56, 60 can be seen. As should be immediately apparent, the extendible platforms 56, 60 are in the closed or non-deployed condition. As such, the extendible platforms 56, 60 are positioned beneath the central platform 40. As discussed above, to permit the extendible platform 56 to slide outwardly from the stowed to the deployed state, the extendible platform 56 includes beams 74. Similarly, to permit the extendible platform 60 to slide from the stowed to the deployed condition, the extendible platform 60 is provided with beams 76. As illustrated in FIG. 8, the beams 74, 76 are positioned in a non-interfering manner beneath the central platform 40.

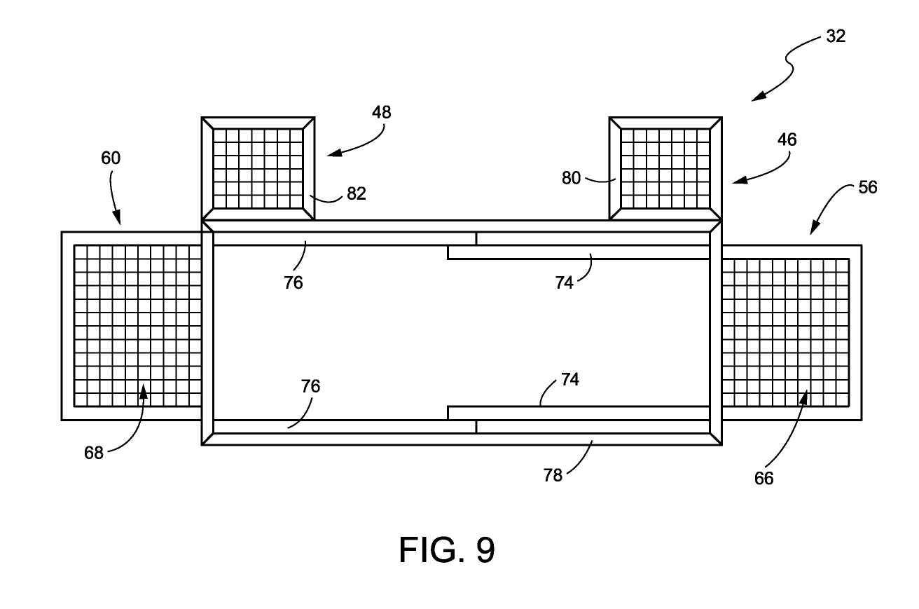

FIG. 9 is a top view of the scaffold 32 illustrated in FIG. 8. Here, the extendible platforms 56, 60 are shown in the opened or deployed condition. As in the prior drawing, the grate defined by the central area 62 has been omitted so that the details of this embodiment of the scaffold 32 may be better appreciated.

With respect to FIGS. 8 and 9, it should be understood that these drawings illustrate one contemplated arrangement for the extendible platforms 56, 60. Those skilled in the art should appreciate that the extendible platforms 56, 60 may be constructed to operate in a manner unlike that illustrated. For example, in the illustrated embodiment, it is contemplated that the extensible platforms 56, 60 will be manually moved between the opened and closed positions. It is contemplated in one variation that the extendible platforms 56, 60 may be operated mechanically and/or remotely.

Additionally, when stowed, the extendible platforms 56, 60 are positioned below the central platform. In a variation of this embodiment, the extendible platforms 56, 60 may be constructed to be above the central platform 40 when in their closed positions.

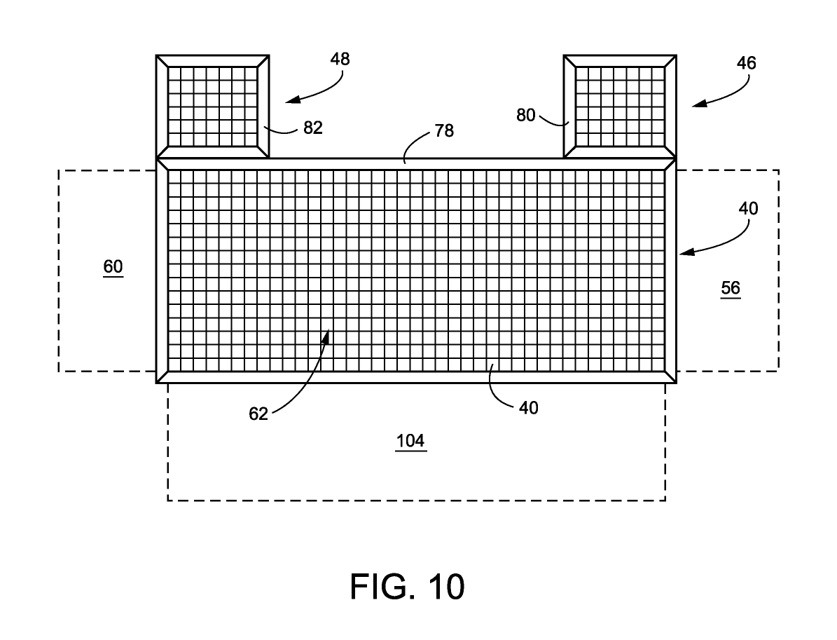

FIG. 10 is a top view of a scaffold 102 of the present invention. Here, the scaffold 102 is intended to have the same construction as the scaffold 32 discussed above. In addition, the scaffold 102 is contemplated to include extendible platforms 56, 60, the opened positions of which are illustrated in dotted line format. This embodiment of the scaffold 102 also is contemplated to include an extendible platform 104 that extends forwardly from the front of the central panel 40. The deployed or opened state of the extendible platform 104 also is illustrated in FIG. 10.

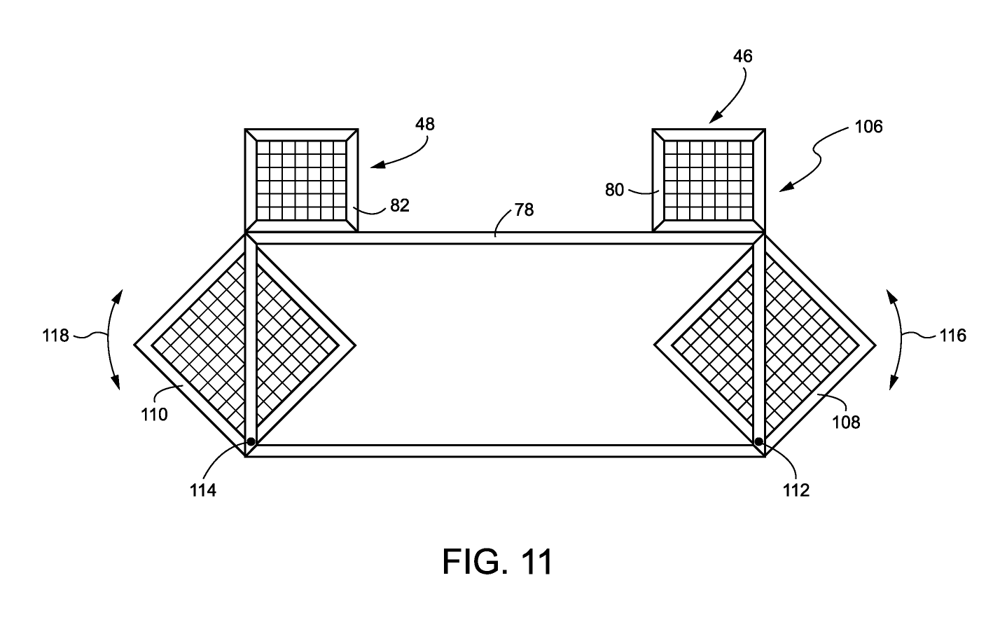

FIG. 11 is a top view of another contemplated embodiment of the present invention. Here, the scaffold 106 includes extendible platforms 108, 110 that pivot outwardly around pivot points 112, 114. The pivot points 112, 114 define axes that are perpendicular to a plane defined by the central area 62 of the central platform 40. The extendible platforms 108, 110 move in the direction of the arrows 116, 118 between opened and closed positions.

In connection with the scaffold 106 that is illustrated in FIG. 11, it is contemplated that the extendible platforms 108, 110 may be permitted to buckle inwardly, should they impact with a tree or other obstruction. For safety reasons, the extendible platforms 108, 110 would not be permitted to collapse completely into the closed position in response to an impact event. However, a modest amount of pivotal motion for the extendible platforms 108,110 (in response to an impact event) is contemplated to minimize damage to the scaffold 106.

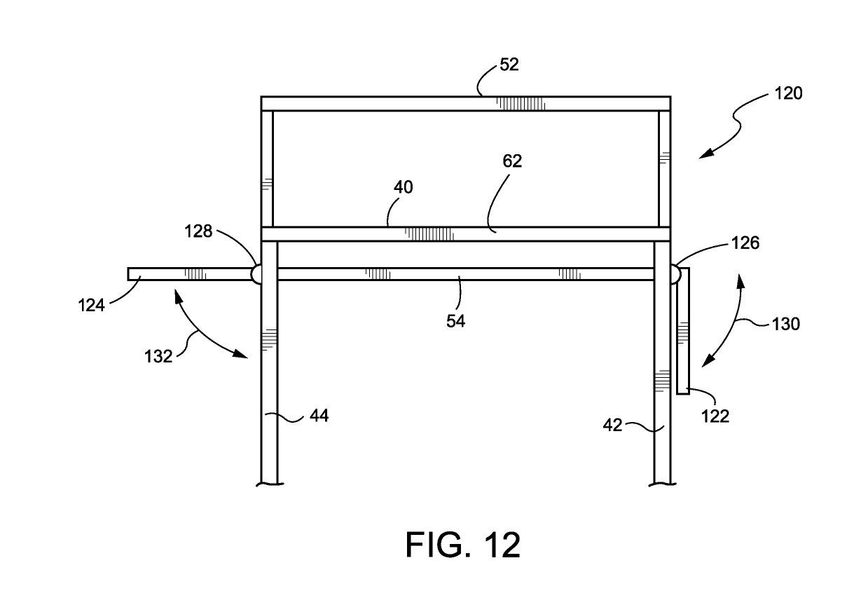

FIG. 12 is a front elevational view of yet another embodiment of the present invention. Here, the scaffold 120 includes two extendible platforms 122, 124 that pivot around pivot points 126, 128. The pivots points 126, 128 define axes that are parallel to a plane defined by the central. area 62 of the central platform 40. The extendible platforms 122, 124 pivot in the direction of the arrows 130, 132 between the opened and closed positions. As should be apparent from FIG. 12, the extendible platform 12-4 is illustrated in the opened position while the extendable platform 122 is shown in the closed position.

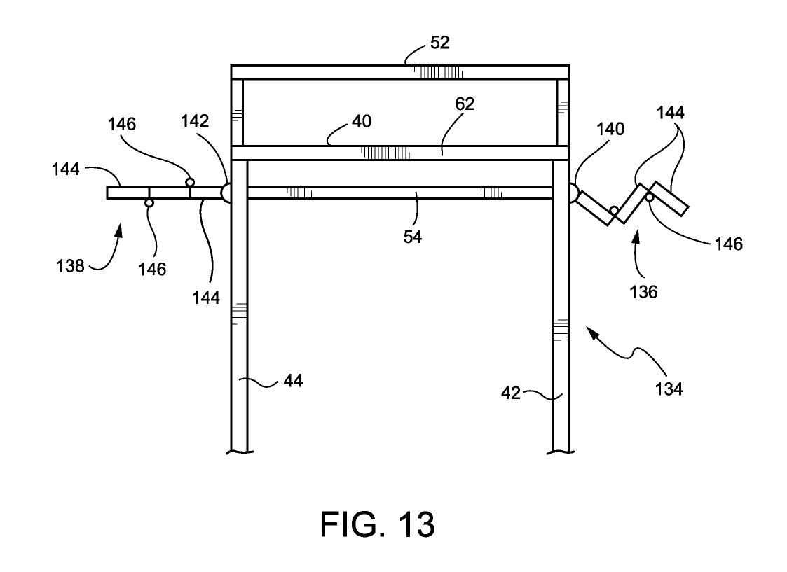

FIG. 13 provides a front elevational view of still one further embodiment of the present invention. Here, the scaffold 134 includes extendible platforms 136, 138 that are attached at pivot points 140, 142. The pivot points 140, 142 define axes that extend parallel to a plane defined by the central area 62 of the central platform 40. Each of the extendible platforms 136, 138 include three platform segments 144 that are connected to one another via hinges 146. The segments 144 are collapsible in an accordion-like fashion from the opened to the closed positions. The extendible platform 138 is shown in the opened position. The extendible platform 136 is shown in a partially collapsed (or partially closed) condition.

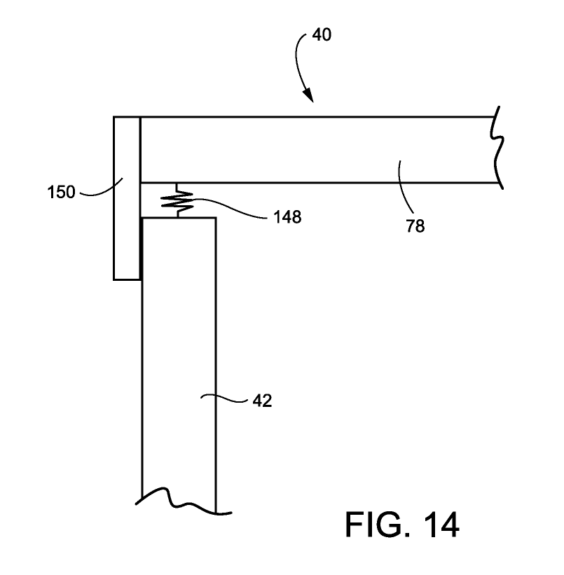

FIG. 14 is a side view illustration of one further aspect of the present invention. This illustration is of the top end of the support 42, beneath the central platform 40. An elastic member 148 is disposed between the frame 78 of the central platform 40 and the top of the support 42. The elastic member 148, which may be a coil spring, for example, provides elastic support for the central platform 40. The elastic member 148 is intended to provide cushioning for the central platform 40. The elastic member 148 may be of any suitable construction contemplated by those skilled in the art. In one contemplated variation, the elastic member 148 may be a shock absorber, for example. To maintain the central platform 40 in proper register with the support 42, one or more guides 150 may be affixed to the frame 78 of the central platform 40.

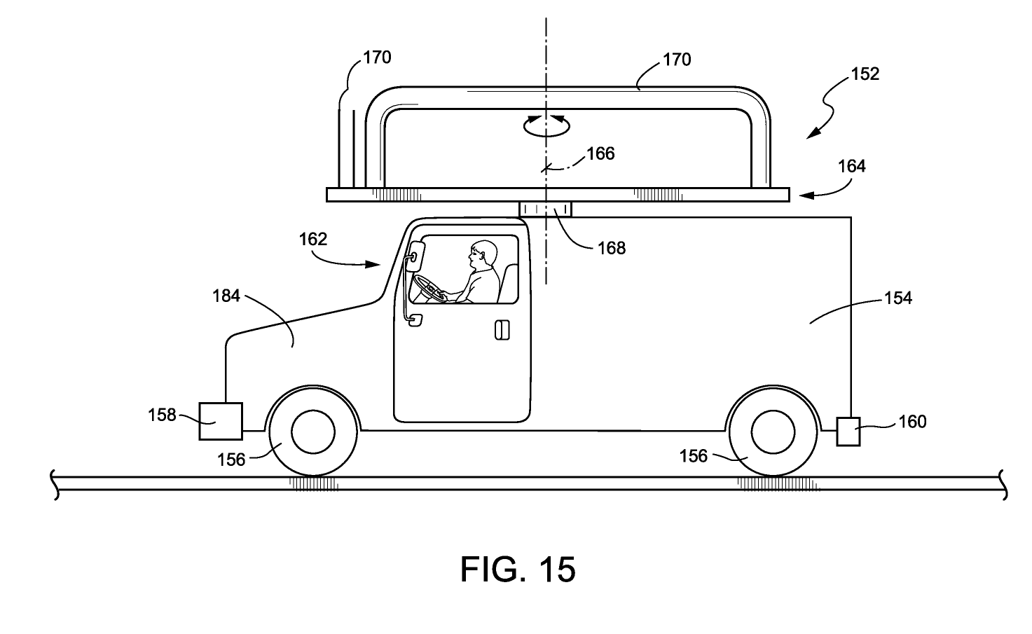

FIG. 15 is a side view illustration of another embodiment of a vehicle 152 according to the present invention. As with the vehicle 10, the vehicle 152 includes a body 154, four wheels 156, a front bumper 156, a rear bumper 158, and a driver's cab 162.

In this embodiment, the vehicle 152 includes a platform 164 that combines the central platform 40 and the extendible platforms 56, 60 of the prior embodiment into a single structure. Here, the platform 164 is affixed to a top of the vehicle 152 in a manner that permits the platform 164 to rotate 360° about a central axis 166. To permit the platform 164 to rotate, the platform 164 is mounted atop a rotating bearing 168, rotating support, or equivalent structure. The platform 164 may include one or more railings 170, as illustrated.

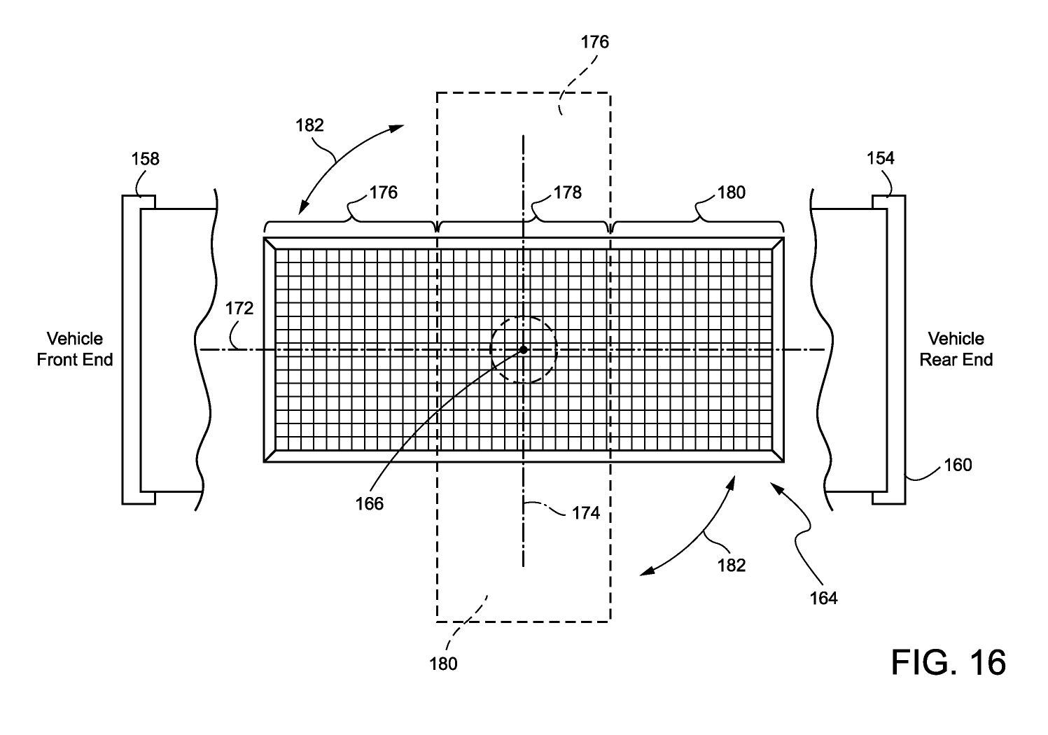

FIG. 16 is a top view of the platform 164 that is shown in FIG. 15. To understand the orientation of the platform 164, the front and rear ends of the vehicle 152 are shown.

In FIG. 16, the platform 164 is shown in a first orientation where the platform 164 is aligned with a centerline 172 of the vehicle 152. The dotted outline 174 of the platform 164 illustrates a second orientation of the platform 164. Here, the platform 164 has been rotated 90 from the first orientation so that a centerline 174 of the platform 164 is now perpendicular to the centerline 172 of the vehicle 152. In this second orientation, end portions of the platform 152 function as the extendible platforms for this embodiment of the present invention.

With continued reference to FIG. 16, the platform 164 defines three support areas, a first extendible area 176, a central area 178, and a second extendible area 180. As noted, the entirety of the platform 164 rotates about the axis 166 in the direction of the arrows 182.

In keeping with the discussion of the present invention, as provided above, the three areas 176, 178, 180 defined by the platform 164 also are referred to as a first extendible platform 176, a central platform 178, and a second extendible platform 180. As in the prior embodiments, the three platforms 176, 178, 180 are contemplated to support one or more operators thereon.

As should be apparent, then, the extendible platforms 176, 180 are made available to an operator upon rotation of the platform 164 about the central axis 166.

It is noted that the platform 164 is placed at a position closer to the center of the vehicle 152 than in the vehicle 10 in the prior embodiment. As should be apparent to those skilled in the art, a support structure may be constructed over the engine compartment 184 of the vehicle 152 to move the location of the platform 164 to a more forward position on the vehicle 152. The precise position of the platform 164 is not critical to operation of the present invention.

As noted above, the exact positions of any of the platforms described herein are not critical to operation of the present invention. The positions may be altered without departing from the scope of the present invention. In addition, the various platforms may be moveable with respect to the vehicle without departing from the scope of the present invention. For example, with reference to the platform 164 on the vehicle 152, the rotating support 168 might be mounted on a track that permits the rotating support 168 to be moved fore and aft with respect to the centerline 172 of the vehicle.

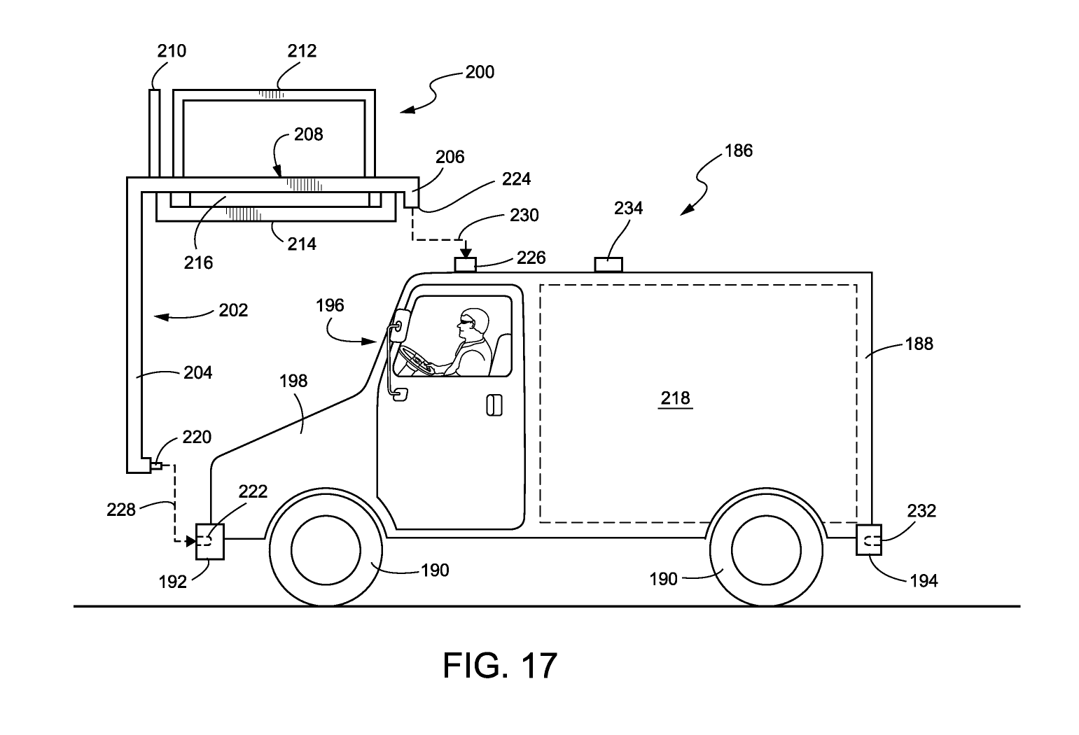

FIG. 17 is a side view of another embodiment of a vehicle 186 according to the present invention. In this embodiment, the vehicle 186 includes a body 188 with wheels 190. A front bumper 192 is disposed at the front of the vehicle 186 and a rear bumper is provided at the rear thereof. A cab 196 is disposed on the vehicle 186, rearward of an engine compartment 198.

In this embodiment, the vehicle 186 is adapted to receive a removable platform 200. The removable platform 200 includes a support frame 202 with a first vertical support 204 and a second vertical support 206. As should be apparent, the first and second supports 204, 206 have complimentary counterparts at the passenger side of the vehicle 186. A greater or fewer number of supports 204, 206 may be employed for the frame 202 without departing from the scope of the present invention.

The supports 202, 204 support a platform 208 in a manner similar to previously-described embodiments. A first handrail 210 is positioned at the forward portion of the removable platform 200. A second handrail 212 is shown at the driver's side of the removable platform 200. As should be understood from previously-described embodiments, it is anticipated that a handrail will be positioned at the passenger side of the removable platform 200. Additionally, while not illustrated, a handrail is anticipated to be positioned at the rear of the platform 208.

The support frame 202 also includes an extendible platform support frame 214. The extendible platform support frame 214 is disposed beneath the platform 208 and provides support for one or more extendible platforms 216. The extendible platforms 216 may be provided in any manner consistent with the embodiments described herein.

As suggested above, the removable platform 200 is contemplated to be removable from the vehicle 186. It is anticipated that the size of the removable platform 200 may be such that the entirety of the removable platform 200 may be stowed in a compartment 218 at the rear of the vehicle 186. Alternatively, the removable platform 200 may be constructed so that it may be disassembled into multiple pieces or segments for stowage in the compartment 218.

So that the removable platform 200 may be stowed in the compartment 218 (or in a separate vehicle), it is contemplated that the removable platform 200 will be constructed from aluminum or other materials (i.e., plastic and/or composite materials) that will decrease the weight of the removable platform 200. The removable platform 200, however, may be made from any suitable material(s) without departing from the scope of the present invention.

As illustrated in FIG. 17, first support 204 includes a tongue 220 protruding from a bottom end. It is contemplated that this tongue 220 will be inserted into a groove 222 in the front bumper 192 so that the removable platform 200 extends above the vehicle 186. Similarly, the bottom end 224 of the second support 206 is contemplated to be insertable into a receiver 226 atop the vehicle 186. The arrows 228, 230 provide an indication of the connections between removable platform 200 and the vehicle 186.

Returning to the tongue 220 and groove 222 connection, while this is contemplated for the illustrated embodiment, any other type of connection may be employed without departing from the scope of the present invention. For example, the first support 204 may be configured in the same manner as the bottom end 224 of the second support 206. If so, one or more receivers may be positioned to protrude from the front bumper 192 to receive the bottom end of the first support 204. As should be appreciated, there are numerous possible equivalents and variations that are possible for this connection. Those equivalents and variations are contemplated to fall within the scope of the present invention.

As also shown in FIG. 17, the vehicle 186 includes a groove 232 in the rear bumper 194. A second receiver 234 is located on top of the vehicle 186. The groove 232 and the receiver 234 are positioned such that the removable platform 200 may be positioned at the rear of the vehicle 186 instead of the front of the vehicle 186. In still further alternative embodiments, the platform 200 may be configurable to extend from either side of the vehicle 186.

In connection with each of the embodiments of the present invention, it is contemplated that the handrails, such as the handrails 210, 212 will be removable or will fold down for stowage. Where the handrails 210, 212 fold down, it is contemplated that the construction will be such that the handrails 210, 212 fold atop one another in a compact manner. As should be appreciated by those skilled in the art however, the handrails 210, 212 may fold in any suitable manner as required or as desired.

In connection with the embodiments described herein, specific heights and dimensions have been excluded because the size and exact configuration of the embodiments is anticipated to vary from vehicle to vehicle and from application to application. For example, it is contemplated that, near interstates, a greater height may be needed. Near country roads and side-streets, a lower height may be desired, in addition, it is contemplated that different states and county regulations will dictate the size of the scaffold of the present invention.

With this in mind, the inventors contemplate that, for one embodiment of the present invention, the platform will permit personnel to trim flora to a height of 20 feet (6.1 meters), as measured vertically from the surface of a road or a shoulder adjacent to a road surface. As noted above, it is contemplated that personnel disposed on the platform will be positioned to trim flora and vegetation to a height of 20 feet (6.1 meters) or to any height required by local laws and regulations. it is also contemplated that a person standing adjacent to the vehicle will be able to trim the flora or vegetation from a position adjacent to the platform to the ground.

It is noted that Occupational Safety and Health Administration (“OSHA”) Standards, as set forth in 29 Code of Federal Regulations (C.F.R.) provide some details concerning the rules and regulations for scaffolds and aerial lifts. Specifically, attention is directed to Part 1926.453. Similarly, the American National Standard for “Vehicle Mounted Elevating and Rotating Work Platforms: ANSI A92.2-1969 addresses safety regulations and rules associated with vehicles of the type described herein.

The discussion set forth above is intended to be more broad that the associated safety regulations. In other words, the disclosure of the present patent application is intended to encompass any number of vehicle designs and constructions, even those that do not fall within any rules or regulations associated with mobile scaffolds. Those skilled in the art, therefore, should not understand the scope of the present invention to be limited to any particular safety regulations, either currently existing or enacted at a future date.

Concerning adjustability of any of the platforms, adjustments may be made manually or with the assistance of a mechanical device. For example, the platforms may be moveable hydraulically or mechanically. In the context of mechanical adjustments, it is contemplated that a mechanical scissor jack might be employed. Still other actuators may be employed without departing front the scope of the present invention.

With respect to each of the platforms described above, it is noted that the term “platform” is intended to be a broad term. in at least one aspect, the term “platform” is intended to refer to any structure that is capable of supporting a person or an operator. This definition is not intended to be limiting of the invention. To the contrary, this definition is presented as an example of the enormous breath contemplated for the present invention.

The present invention has been described in connection with several contemplated embodiments. As noted above, the present invention is not intended to be limited by those embodiments. To the contrary, the embodiments that are described are intended to illustrate the broad scope of the present invention. Variations and equivalents that are contemplated by those skilled in the art are intended to be encompassed by the present invention.

What is claimed is:

1. A scaffold, comprising:
a central platform with a top surface defining a. central area, a bottom, a first lateral side a second lateral side, and a front side;
a plurality of supports connected to and supporting the platform; and
at least one extendible platform connected adjacent to the central platform, the extendible platform having a top surface defining an extendible area, the at least one extendible platform being adjustable between an opened position and a closed position, the opened position presenting the extendible area for use, the closed position stowing the extendible area from use.

2. The scaffold of claim 1, wherein the at least one extendible platform is connected adjacent to one of either the first lateral side or the second lateral side of the central platform.

3. The scaffold of claim 1, wherein the at least one extendible platform is connected adjacent to the front side.

4. The scaffold of claim 1, wherein the extendible platform slides to a position beneath the central platform from the opened position to the closed position.

5. The scaffold of claim 1, wherein the at least one extendible platform pivotally rotates, about a vertical axis perpendicular to a plane defined by the central area, to a position beneath the central platform from the opened position to the closed position.

6. The scaffold of claim 1, wherein, the at least one extendible platform collapses from the opened position to the closed position by pivoting along a horizontal axis parallel to a plane defined by the central area.

7. The scaffold of claim 1, wherein the at least one extendible platform comprises a first extendible platform positioned adjacent to the central platform at the first lateral side and a second extendible platform positioned adjacent to the central platform at the second lateral side.

8. The scaffold of claim 1, wherein the plurality of supports are connected to and support the central platform from the bottom of the central platform.

9. The scaffold of claim 1, wherein the at least one extendible platform is at a height that differs from a height of the central platform.

10. A method of use for the scaffolding of claim 1, comprising:
extending the at least one extendible platform from the closed position to the opened position;
disposing an operator on the scaffold;
positioning the scaffold at a first position;
permitting performance of a first operation from the scaffold at the first position by the operator;
positioning the scaffold at a second position; and
permitting performance of a second operation from the scaffold at the second position by the operator,
wherein the scaffold is moved from the first position to the second position while the operator is disposed thereon.

11. A vehicle, comprising:
a body;
a plurality of wheels supporting the body to establish a mobile unit;
a steering device adapted to steer the body; and
a scaffold, comprising
a central platform with a top surface defining a central area, a bottom, a first lateral side, a second lateral side, and a front side,
a plurality of supports connected to and supporting the platform, and
at least one extendible platform connected adjacent to the central platform, the extendible platform having a top surface defining an extendible area, the at least one extendible platform being adjustable between an opened position and a closed position, the opened position presenting the extendible area for use, the closed position stowing the extendible area from use.

12. The vehicle of claim 11, wherein the at least one extendible platform is connected adjacent to one of either the first lateral side or the second lateral side of the central platform.

13. The vehicle of claim 11, wherein the at least one extendible platform is connected adjacent to the front side.

14. The vehicle of claim 11, wherein the extendible platform slides to a position beneath the central platform from the opened position to the closed position.

15. The vehicle of claim 11, wherein the at least one extendible platform pivotally rotates, about a vertical axis perpendicular to a plane defined by the central area, to a position beneath the central platform from the opened position to the closed position.

16. The vehicle of claim 11, wherein the at least one extendible platform collapses from the opened position to the closed position by pivoting along a horizontal axis parallel to a plane defined by the central area.

17. The vehicle of claim 11, wherein the at least one extendible platform. comprises a first extendible platform positioned adjacent to the central platform at the first lateral side and a second extendible platform positioned adjacent to the central platform at the second lateral side.

18. The vehicle of claim 11, wherein the at least one extendible platform is at a height that differs from a height of the central platform.

19. A method of use of the vehicle of claim 11, comprising:
extending the at least one extendible platform from the closed position to the opened position;
disposing an operator on the scaffold;
positioning the vehicle at a first position;
permitting performance of a first operation from the scaffold at the first position by the operator;
positioning the vehicle at a second position; and
permitting performance of a second operation from the scaffold at the second position by the operator,
wherein the vehicle is moved from the first position to the second position while the operator is disposed on the scaffold.

20. The method of claim 19 wherein the first and second operations involve manipulation of flora adjacent to a road.
